(19) United States
(12) Patent Application Publication
(10) Pub. No.: US 2016/0025319 A1
(43) Pub. Date: Jan. 28, 2016

(54) HOLDER, HOLDER ASSEMBLY AND LED ASSEMBLY USING HOLDER ASSEMBLY

(71) Applicants: Gregory P. MEYER, (US); MOLEX, LLC, Lisle, IL (US)

(72) Inventor: Gregory P. MEYER, Elk Grove Village, IL (US)

(73) Assignee: Molex, LLC, Lisle, IL (US)

(21) Appl. No.: 14/774,572

(22) PCT Filed: Mar. 10, 2014
(86) PCT No.: PCT/US2014/022672

§ 371 Date: Sep. 10, 2015

Related U.S. Application Data
(60) Provisional application No. 61/776,360, filed on Mar. 11, 2013.

(51) Int. Cl. F21V 23/06

(52) U.S. Cl. CPC F21V 23/06; F21Y 2105/001

(57) ABSTRACT

A LED assembly is disclosed. In an embodiment, the LED assembly includes a holder assembly and a circuit board assembly. The holder assembly includes a holder that is configured to support an LED array and provide electrical connection to the LED array. The circuit board assembly includes two terminals are configured to provide electrical connection to the holder assembly. The holder assembly can have a first orientation while the circuit board can have a second orientation.

### RELATED APPLICATIONS

This application claims priority to U.S. Provisional Application No. 67/776,360, filed Mar. 11, 2013, which is incorporated herein by reference in its entirety.

### FIELD OF THE INVENTION

The present invention relates to field of illumination using a light emitting diode (LED), more specifically to an LED assembly that includes a holder suitable for supporting an LED array.

### DESCRIPTION OF RELATED ART

Holders are known to be useful to support LED arrays. LED arrays tend to need to be connected to an electrical power source and this becomes more challenging as the LED array shrinks in size. Sometimes holders have been provided that can mount to a substrate and secure the LED array in position when the holder is attached to the substrate while provide for an integrated connector on a side that could be used to power the LED array. However, such a design is not always preferred for all applications.

One application where users might benefit from a variation is in a replacement bulb application. Typically LED-based replacement bulbs need to be made extremely cost effectively. Because of the still reasonably low volumes, which has a circular effect on raising the costs, it often makes sense to have various portions of an LED-based bulb be manually assembled. Due to the space constraints, this tends to result in a design that requires soldering of wires in order to connect to the anode and cathode of the LED array to a power supply. While manual operations can provide high quality products, sometimes there are issues with the quality of such designs and certain bulb manufactures have been forced to recalled bulbs to address potential quality issues. Therefore further refinements and improvements to existing holder designs would be appreciated by certain individuals.

### BRIEF SUMMARY

A LED assembly is disclosed. In an embodiment, the LED assembly includes a holder assembly and a circuit board assembly. The holder assembly is configured to support an LED array and includes two holder terminals that are electrically connected to pads on the LED array. The circuit board assembly includes two terminals, each of which can be supported by a connector, and can including circuitry to control power delivery to LEDs on the LED array. The terminals are configured to be electrically coupled to the holder terminals. In an embodiment, the terminals can be elongated and be configured to be inserted into a pin-receiving notch in the holder terminals that includes a tapered section and a retaining hole.

### BRIEF DESCRIPTION OF THE DRAWINGS

The present invention is illustrated by way of example and not limited in the accompanying figures in which like reference numerals indicate similar elements and in which:

FIG. 1 illustrates a perspective view of an embodiment of an LED assembly.

FIG. 2 illustrates a partially exploded view of the embodiment depicted in FIG. 1.

FIG. 3 illustrates a perspective view of an embodiment of a holder assembly.

FIG. 4 illustrates a partially exploded perspective view of a holder assembly.

FIG. 5 illustrates a perspective simplified view of an embodiment of a holder assembly.

FIG. 6 illustrates a perspective view of a cross section taken along line 6-6 in FIG. 5.

FIG. 7 illustrates a perspective view of a cross section taken along line 7-7 in FIG. 4.

FIG. 8 illustrates a perspective view of an embodiment of holder terminals suitable for use in a holder assembly.

FIG. 9 illustrates an elevated side view of a cross-section of a pin-receiving notch in a holder terminal.

FIG. 10 illustrates a perspective view of a cross-section taken along line 10-10 in FIG. 3.

FIG. 11 illustrates an elevated side view of an embodiment of a holder terminal

FIG. 12 illustrates an elevated side view of an embodiment of an alternative holder terminal suitable for use with a holder assembly.

### DETAILED DESCRIPTION

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

LED holders often are used in configurations where a larger support surface can be used as a heat sink. For example, a fixture might be configured to support one or more LED holders. While such configurations are useful, it has been determined that there are other uses that make provide surprising benefits. In a bulb shaped like an R-30 bulb, for example, it is common to solder electrical connections to an LED array and often this is a manual process because it is difficult to automate the routing of wires. It has been determined that other methods, such as what is disclosed herein, can provide improvements in reliability by improving the reliability of the assembly process. The depicted embodiments also provide for an advantageous assembly process where a holder assembly can be mated to a circuit board assembly. As is known, it is often desirable to pot circuit boards with circuitry to help provide more efficient thermal management and the depicted embodiment allows for this potting to take place without the holder assembly being part of the process and while still providing a simple assembly process that doesn't require hand soldering. Thus, a number of potential benefits are provided by the depicted design features.

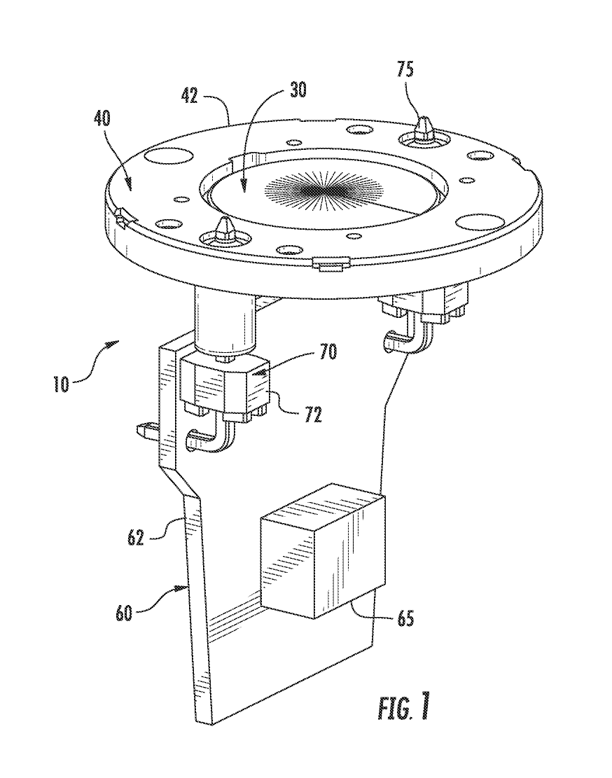

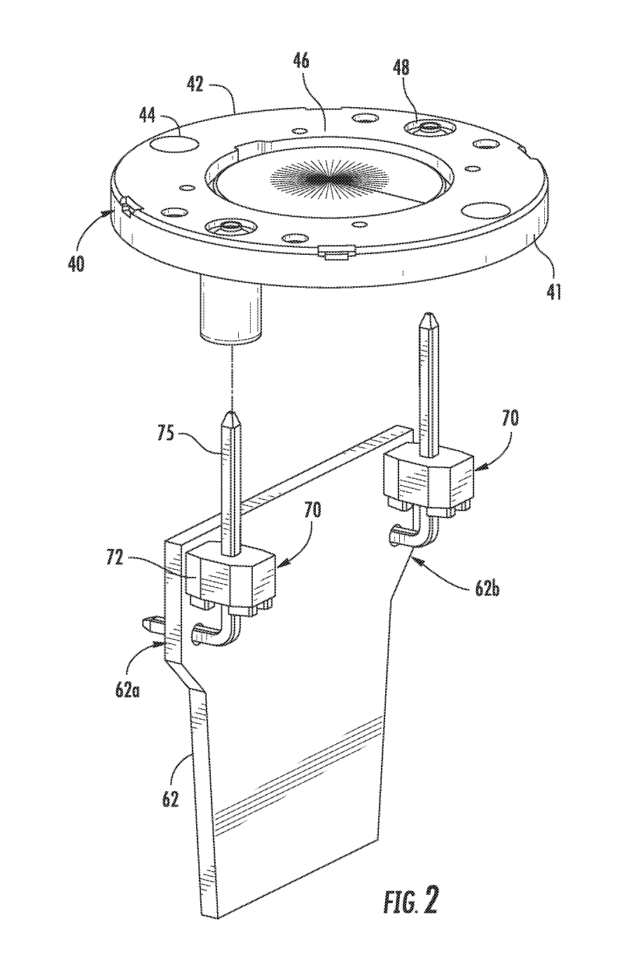

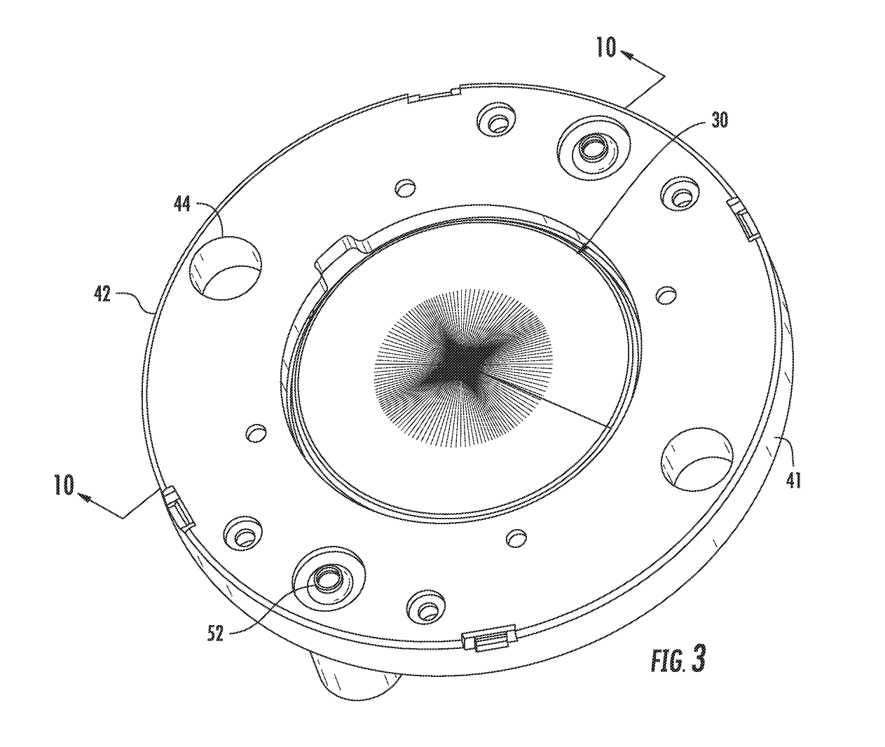

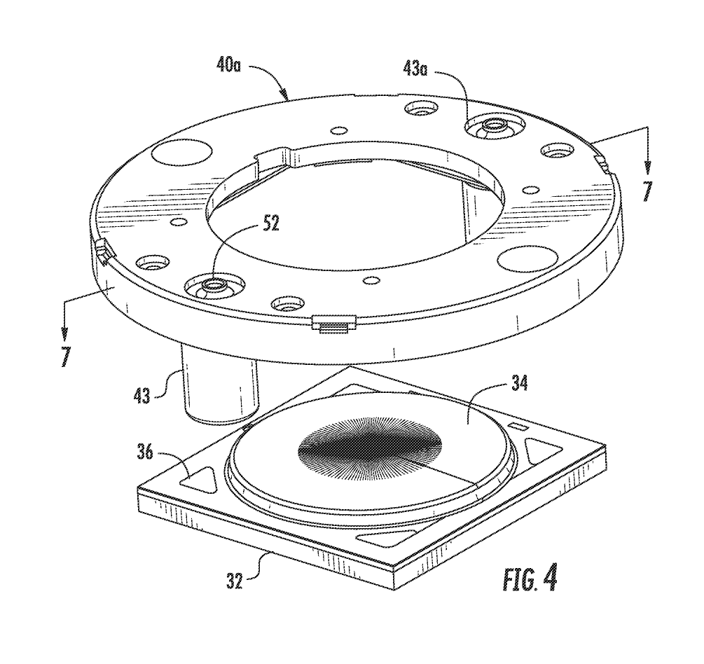

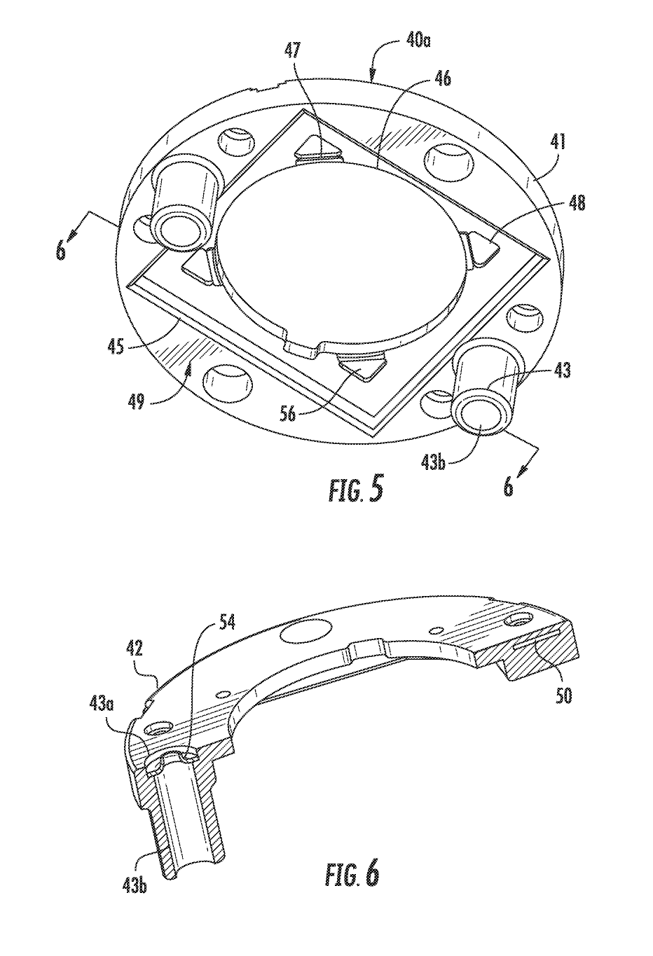

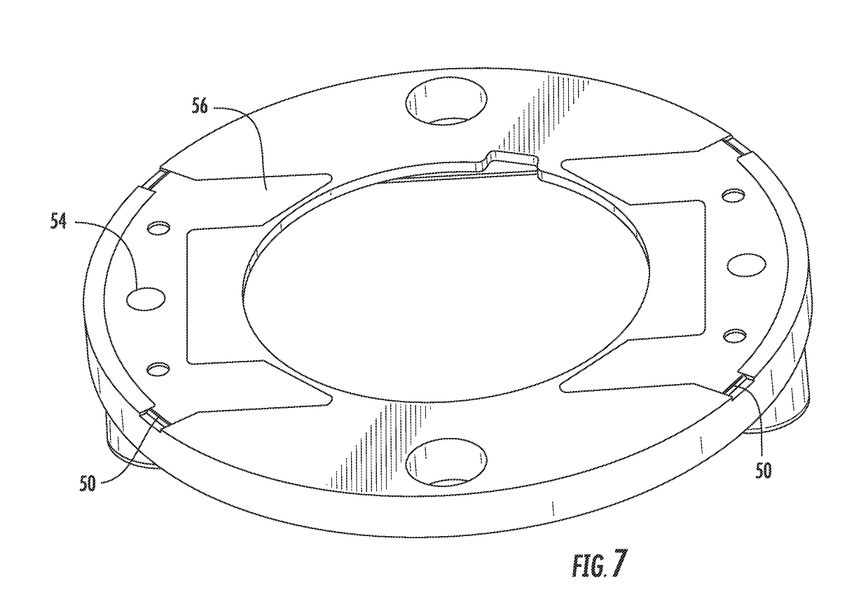

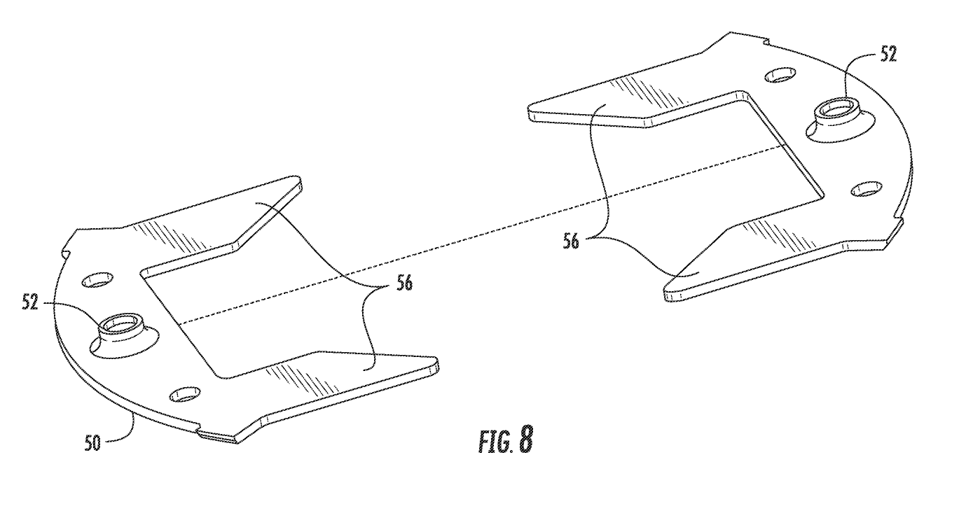

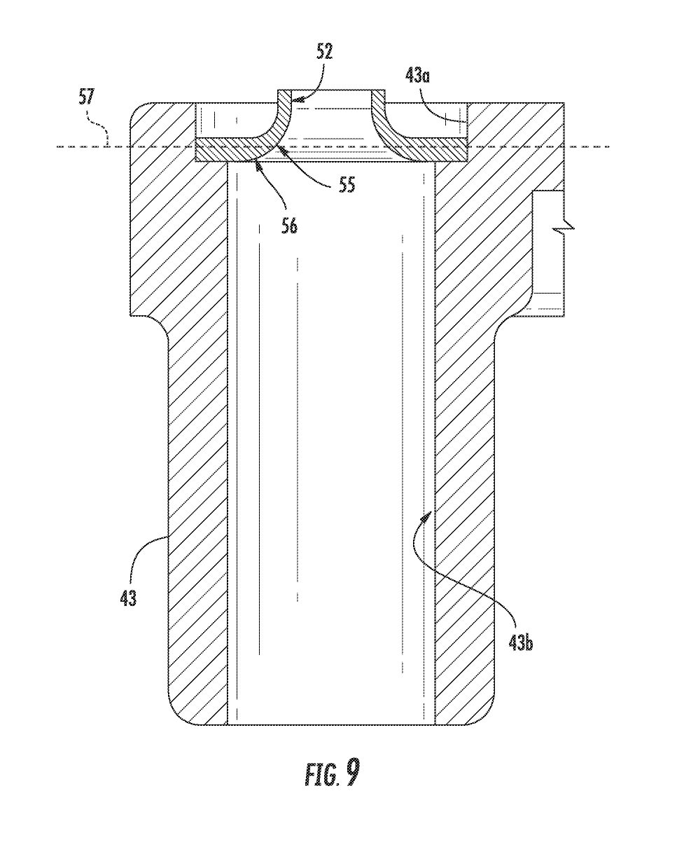

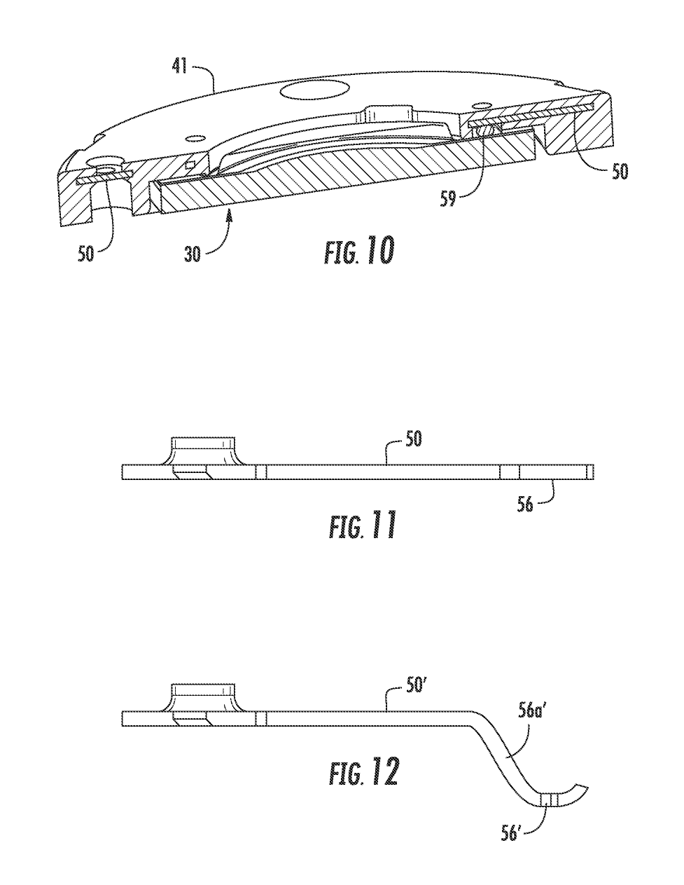

FIGS. 1-12 illustrate features of embodiments of a LED assembly 10 and components that could be used with an LED assembly to provide for use in a bulb replacement configuration (although it is not limited to such applications). The LED assembly 10 includes a holder assembly 40 that is electrically connected to a circuit board assembly 60. As depicted, the holder assembly 40 is arranged along a first plane (e.g., a horizontal plane) and the circuit board assembly 60 is arranged along a second plane (e.g., a vertical plane). Thus the orientation of the holder assembly 40 can be substantially perpendicular to the orientation of the circuit board assembly 60.

The circuit board assembly 60 that includes circuitry 65 on a circuit board 62. The circuitry 65 can include AC to DC capabilities and can act as a driver (e.g., a constant current driver). Alternatively, for configurations where DC power is being supplied to the circuitry 65, the circuitry 65 can simply act as a driver and/or provide controls for when the power is to be supplied. Naturally, the circuitry 65 can include features such as a transceiver that allows it to receive and send information. As can be appreciated, while depicted as a single, integrated block, separate components can be connected together to form the desired circuitry and provide the desired functionality.

The circuit board 62 supports a connector 70 that includes a housing 72 and the housing 72 helps support a terminal 75 that is electrically connected to the circuit board 62. While not required, it may be desirable for the housing 72 and/or the circuit board 62 to have one or more alignment features so as to help ensure the orientation of the terminal 75 with respect to the circuit board 62 is properly controlled. A slot and a shoulder, for example, could be used to help control orientation of the terminal with respect to the circuit board. It should be noted that as depicted, two separate connectors 70 are provided, one on a first side 62a of the circuit board 62 and the other on a second side 62b of the circuit board 62 and each connector supports one of the terminals 75. In an alternative embodiment a single connector could support two terminals 75 and the terminals 75 could be positioned closer together. The terminals 75 are configured to deliver power to the holder assembly 40.

The holder assembly 40 includes a holder housing 41 that supports an LED array 30. The LED array 30 includes pads 36 (e.g., first and second pads) on a substrate 32 that are configured to act as an anode and cathode for an LED block 34 that supported by the LED array. The LED block 34 includes one or more LEDs in wired in series and typically includes a silicone layer to protect the LEDs and may also include a phosphor layer to convert the emitted light to a more desirable set of wavelengths. One potential construction of the LED array 30 is what is known as a chip on board (COB) LED array.

The holder housing 41 includes a base 42 with an aperture 46 that allows the LED array 30 to emit light through the aperture 46 and the base 42 includes a lower surface 49. A wall 45 defines a recess that is configured to accept the substrate 32 of the LED array 30. Terminal openings 48 (e.g., first and second terminal openings) are provided in the lower surface 49. Extension channels 43 are depicted on opposing sides of the aperture 46 (e.g., along two opposing sides of the wall 45).

The base 42 supports holder terminals 50 (e.g., first and second holder terminals) that include contacts 56 that are electrically connected to pads 36 of the LED array 30. As depicted, a solder mass 59 is positioned in the terminal opening 48 and electrically connects the contacts 56 to the pads 36, thus the contacts 56 are soldered to the pads 36. This provides a secure electrical connection between the holder terminals 50 in the holder housing 41 and the pads 36 of the LED array 30. As depicted, the terminal openings 48 include a solder dam 47 that helps protect the LED array 30 from solder during a reflow operation. It should be noted that while four terminal openings are disclosed, some other number such as two or more terminal openings, could be provided.

In an alternative embodiment, as depicted in FIG. 12, a holder terminal 50′ with a contact 56′ could include an arm 56a′ that was configured to deflect and engage the pads 36 through the terminal opening 48 when the LED array 30 was mounted to the base 42. Naturally, the shape and size of the terminal opening might vary, depending on the construction of the holder terminal In such an embodiment, as can be appreciated, the contacts and pads would not be soldered together and instead the LED array 30 could be secured to the holder housing 41 via heat staking or other conventional fasteners. In addition, the LED array 30 could have an interference fit with the holder housing 41 (e.g., the wall 45 could be sized so that the substrate 32 had an interference fit with the wall 45) that would hold the LED array 30 in place until the holder assembly 40 was connected circuit board assembly 60 (which in turn could be part of a more complete LED assembly that could include a heat sink and a lens, among other features). Thus, a number of alternative methods could be used to secure the LED array to the holder 40a if the holder terminal was configured to engage the pads without solder attachment.

Regardless of how the holder terminals 50 connects to the pads 36, the previously discussed terminals 75 connect to the holder terminal 50 to provide power to the holder terminals 50 (and the LEDs supported by the LED array 30). The holder terminal 50 includes a pin-receiving notch 54 with a tapered section 55 that necks down to a retaining hole 52. In operation, the terminal 75 is inserted into the pin-receiving notch 54 and the two are configured so that the terminal 75 has an interference fit with the holder terminal 50. As can be appreciated, the extension channel 43 is provided that extends from the base 42 and as depicted, is shaped like a column with an open interior 43b. The extension channel 43 is further depicted with a top opening 43a. The extension channel 43 is aligned with the pin-receiving notch 54 and can effectively provide an insulative sleeve around the terminal 75. In an embodiment, the extension channel 43 can extend a distance that is at least 50% greater than a thickness of the base 42. For example, if the base was 2.0 mm thick then the extension channel 43 could extend at least 3.0 mm from the lower surface 49 of the base 42.

It should be noted that just two terminals 75 are disclosed. While only two terminals 50 are needed to provide power, additional terminals could be provided. In such an embodiment additional holder terminals could be supported by the holder assembly and each terminal could be configured to engage a separate pad on the corresponding array. Naturally, such a construction would primarily be useful if the LED array had more than one series of LEDs such that the different serious of LEDs could be separately powered.

The disclosure provided herein describes features in terms of preferred and exemplary embodiments thereof Numerous other embodiments, modifications and variations within the scope and spirit of the appended claims will occur to persons of ordinary skill in the art from a review of this disclosure.

We claim:

1. A holder, comprising:
a holder housing have an aperture and a first terminal opening and a second terminal opening positioned along the aperture, the first and second terminal openings spaced apart, the housing further including a first extension channel and a second extension channel;
a first holder terminal supported by the holder housing with a pin-receiving notch aligned with the first extension channel, the first holder terminal including a contact positioned in the first terminal opening; and
a second holder terminal supported by the holder housing with a pin-receiving notch aligned with the second extension channel, the second holder terminal including a contact positioned in the second terminal opening.

2. The holder of claim 1, wherein the first holder terminal is provided along a first centerline and the pin-receiving notch extends in a first direction from the centerline and the first extension channel extends a second direction, the first and second direction being substantially opposite.

3. The holder of claim 1, wherein the holder housing has a wall on a lower surface, the wall defining a recess.

4. The holder of claim 3, wherein the first and second extension channels are provided along opposing sides of the wall.

5. A holder assembly, comprising:
a holder housing have an aperture and a first terminal opening and a second terminal opening positioned along the aperture, the first and second terminal openings spaced apart, the holder housing further including a first extension channel and a second extension channel;
a first holder terminal supported by the holder housing with a pin-receiving notch aligned with the first extension channel, the first holder terminal including a contact positioned in the first terminal opening;
a second holder terminal supported by the holder housing with a pin-receiving notch aligned with the second extension channel, the second holder terminal including a contact positioned in the second terminal opening; and
an LED array supported by the holder housing, the LED array having a substrate with a first pad and a second pad, the first and second pads electrically connected, respectively, to the first and second holder terminals.

6. The holder assembly of claim 5, wherein the pads are electrically connector to the holder terminals via a solder mass.

7. The holder assembly of claim 5, wherein the holder housing has a wall that defines a recess configured to receive the substrate and substrate has an interference fit with a wall.

8. An LED assembly, comprising:
a holder housing have an aperture and a first terminal opening and a second terminal opening positioned along the aperture, the first and second terminal openings spaced apart, the holder housing further including a first extension channel and a second extension channel;
a first holder terminal supported by the holder housing with a pin-receiving notch aligned with the first extension channel, the first holder terminal including a contact positioned in the first terminal opening;
a second holder terminal supported by the holder housing with a pin-receiving notch aligned with the second extension channel, the second holder terminal including a contact positioned in the second terminal opening;
an LED array supported by the holder housing, the LED array have a first pad and a second pad electrically connected, respectively, to the first and second holder terminals;
a circuit board assembly supporting a first terminal and a second terminal, the first and second terminals electrically connected, respectively, to the pin-receive notches of the first and second holder terminals.

9. The LED assembly of claim 8, wherein the circuit board supports a housing, the housing helping to support and control an orientation of the first terminal.

10. The LED assembly of claim 8, wherein the holder assembly is in a first orientation and the circuit board is in a second orientation, the first and second orientation being substantially perpendicular to each other.
